(19) United States
(12) Patent Application Publication
(10) Pub. No.: US 2006/0108498 A1
(43) Pub. Date: May 25, 2006

(54) Apparatus for displaying more than one ornamental object on a structure

(76) Inventor: Jeffrey A. Jackson, Alpharetta, GA (US)

Correspondence Address: SHEEHAN PHINNEY BASS & GREEN, PA;c/o PETER NIEVES, 1000 ELM STREET, MANCHESTER, NH, 03105-3701, US

(21) Appl. No.: 11/327,938

(22) Filed: Jan. 9, 2006

Related U.S. Application Data
(63) Continuation-in-part of application No. 10/816,097, filed on Apr. 1, 2004.
Application No. 10/816,097 is a continuation-in-part of application No. 10/346,153, filed on Jan. 16, 2003, now Pat. No. 6,848,660.

(51) Int. Cl. A47G 29/00; F16M 11/00

(52) U.S. Cl. 248/690

(57) ABSTRACT

An apparatus for releasably and adjustably supporting a first object and a second object on a structure contains an elongated portion having a top surface and a bottom surface, and having a proximate end and a distal end. A central loop portion extends from the proximate end of the elongated portion. The central loop portion contains an eyelet that is entirely enclosed on a top portion, a bottom portion, a front portion, and a back portion of the eyelet, and the eyelet being open on a left side portion and a right side portion of the eyelet, wherein the eyelet is capable of allowing a second object to be situated in the eyelet after being placed within the left side portion or the right side portion of the eyelet. A hook portion extends from the central loop portion, wherein the hook portion is capable of allowing a first object to be set thereon. The apparatus also contains an end support capable of being adjustably connected to the elongated portion so as to allow the apparatus to hold to the structure, based upon size of the structure.

### CROSS-REFERENCE TO RELATED APPLICATIONS

The present application is a continuation-in-part of copending U.S. patent application Ser. No. 10/816,097, filed Apr. 1, 2004, and having the title “APPARATUS FOR DISPLAYING ORNAMENTAL OBJECTS,” which is a continuation-in-part of U.S. Pat. No. 6,848,660, issued Feb. 1, 2005, the entire disclosures of which are incorporated herein by reference.

### FIELD OF THE INVENTION

The present invention generally relates to an apparatus for displaying articles. More specifically, the invention is related to an apparatus for hanging articles from a structure such as, but not limited to, a rail of a deck, where the apparatus can accommodate structures of different sizes.

### BACKGROUND OF THE INVENTION

Typically, each year during the holiday season festive decorations are arranged on structures such as Christmas trees, fireplace mantles, banisters, and deck railing. Typical methods used for arranging decorations on structures include the use of adhesive tapes and fasteners, where an example of a fastener may include a metallic or plastic tie.

As an example, when hanging garland from railing of a deck, adhesive tape is typically used to wrap the garland and prevent displacement of the garland. When using adhesive tape, a piece of adhesive tape is cut and the garland is stuck to the railing by wrapping the adhesive tape around the railing with the garland there between. Unfortunately, removal of the adhesive tape and garland is tedious since the adhesive tape sticks to the garland and, depending of the adhesive characteristics of the adhesive tape, may even stick to the railing of the deck. Therefore, when removing the adhesive tape and garland, a portion of the adhesive tape may either stick to the deck railing resulting in a portion of the garland being removed with removal of the adhesive tape, or during removal, damage a portion of the deck railing by pulling a finished coating off of the deck railing.

Unfortunately, the use of fasteners is quite tedious since fasteners are typically tied or placed every few feet to secure the garland to the deck railing and provide an ornamental design. In addition, when removing the garland from the deck railing, the individual is required to find each individual tie and unwrap each tie prior to removal of the garland from the deck railing.

It is also common to desire to hang more than one object from the deck railing at the same time. As an example, a homeowner may wish to hang garland and lights from the deck railing at the same time. As a result, additional adhesive tape and/or fasteners may be used, thereby adding to complexity in adding and removing the garland and lights to and from the deck railing. It should be noted that with use of additional adhesive tape and/or fasteners, the second article may appear less presentable and not meet the expectations of the homeowner.

In addition to the above-mentioned, size of the deck railing may differ (e.g., width of the deck railing). As a result, large and small pieces of adhesive tape and large and small fasteners may be required to decorate the same deck of a home.

Thus, a heretofore unaddressed need exists in the marketplace to address the aforementioned deficiencies and inadequacies.

### SUMMARY OF THE INVENTION

Embodiments of the present invention provide an apparatus for releasably and adjustably supporting a first object and a second object on a structure. Briefly described, in architecture, one embodiment of the apparatus, among others, can be implemented as follows. The apparatus contains an elongated portion having a top surface and a bottom surface, and having a proximate end and a distal end. A central loop portion extends from the proximate end of the elongated portion. The central loop portion contains an eyelet that is entirely enclosed on a top portion, a bottom portion, a front portion, and a back portion of the eyelet, and the eyelet being open on a left side portion and a right side portion of the eyelet, wherein the eyelet is capable of allowing a second object to be situated in the eyelet after being placed within the left side portion or the right side portion of the eyelet. A hook portion extends from the central loop portion, wherein the hook portion is capable of allowing a first object to be set thereon. The apparatus also contains an end support capable of being adjustably connected to the elongated portion so as to allow the apparatus to hold to the structure, based upon size of the structure.

Other apparatus and advantages of the present invention will be, or become, apparent to one with skill in the art upon examination of the following drawings and detailed description. It is intended that all such additional apparatus and advantages be included within this description, be within the scope of this invention, and be protected by the accompanying claims.

### BRIEF DESCRIPTION OF THE DRAWINGS

The present invention will be more fully understood from the detailed description given below and from the accompanying drawing of the embodiments of the invention, which however, should not be taken to limit the invention to the specific embodiments enumerated, but are for explanation and for better understanding only. Furthermore, the drawings are not necessarily to scale, emphasis instead being placed upon clearly illustrating the principles of the invention. Finally, like reference numerals in the figures designate corresponding parts throughout the several drawings.

FIG. 1 is a perspective view of a clip, in accordance with a first exemplary embodiment of the invention.

FIG. 2 is a side view of the clip of FIG. 1.

FIG. 3 is a cross-sectional view of the clip of FIG. 1.

FIG. 4 is a perspective view of a main body of the clip of FIG. 1.

FIG. 5 is a side view of the main body of FIG. 4.

FIG. 6 is a perspective view of an end support of the clip of FIG. 1.

FIG. 7 is a cross-sectional view of the end support of FIG. 6.

### DETAILED DESCRIPTION

The present invention is an apparatus, namely a clip, to support or suspend objects therefrom in a releasable manner. The clip may support many types of articles, such as, but not limited to, garland and a bow. It should be noted, however, that the clip might support other articles not mentioned herein, such as, but not limited to, ornaments. Though the clip can be attached to many different surfaces as explained herein, the clip is described herein as being supported on railing of a deck.

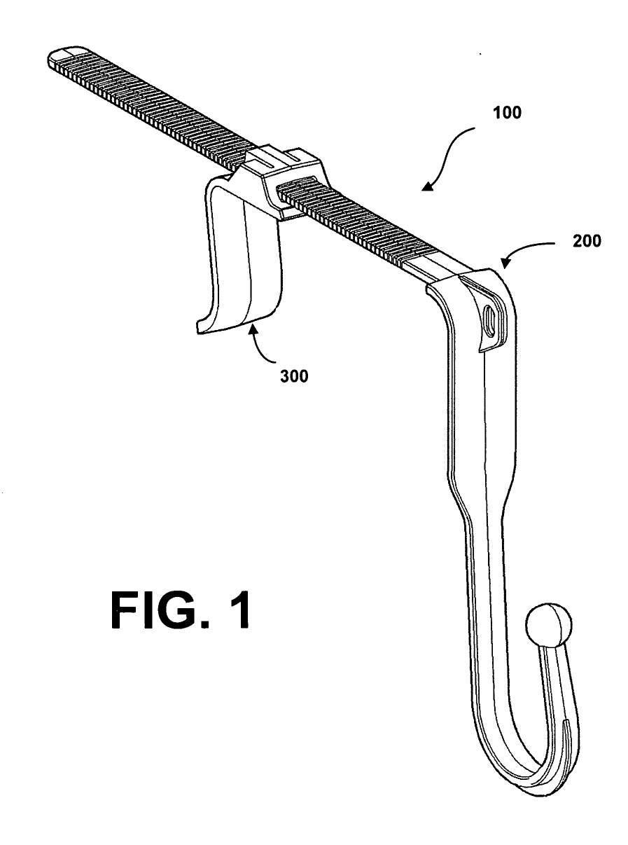

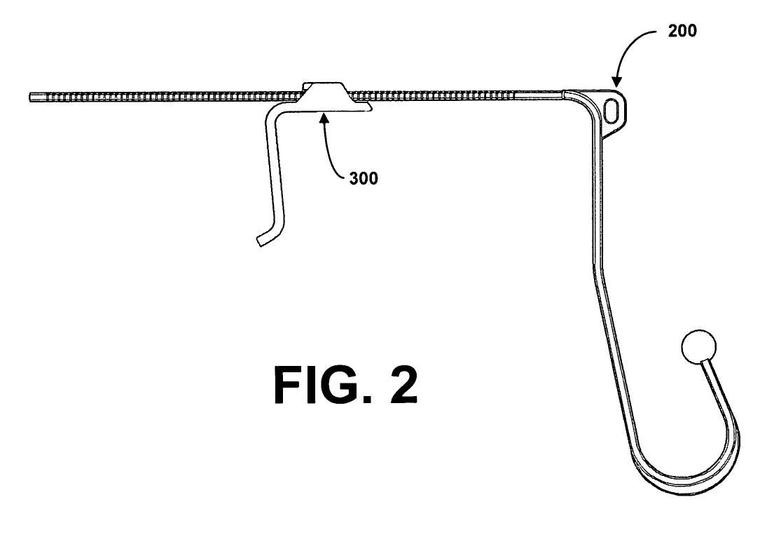

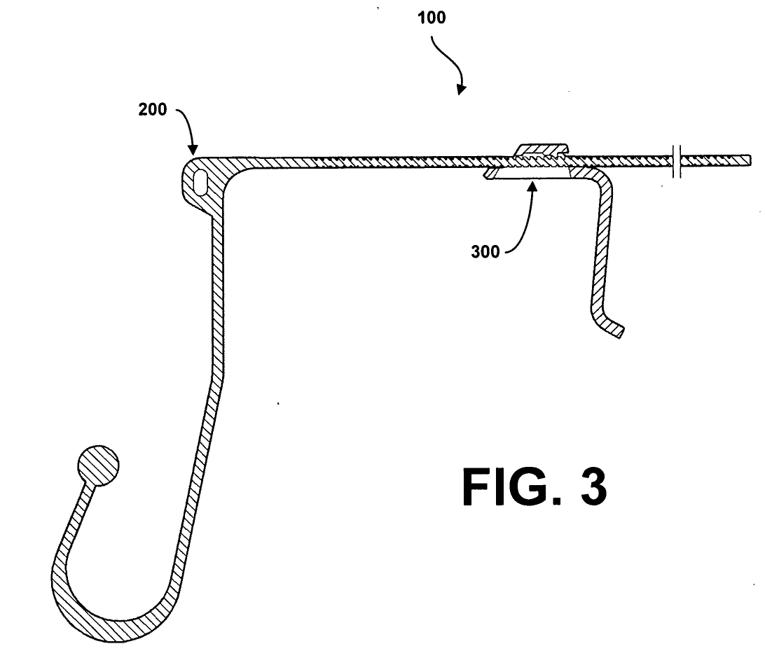

Referring now to the drawings, wherein like reference numerals designate corresponding parts throughout the drawings, FIG. 1 is a perspective view of the clip 100. The clip 100 may also be viewed by FIG. 2, which is a side view of the clip 100 of FIG. 1, and FIG. 3, which is a cross-sectional view of the clip 100. Referring to FIG. 1, FIG. 2, and FIG. 3, the clip 100 has a main body 200 and an end support 300.

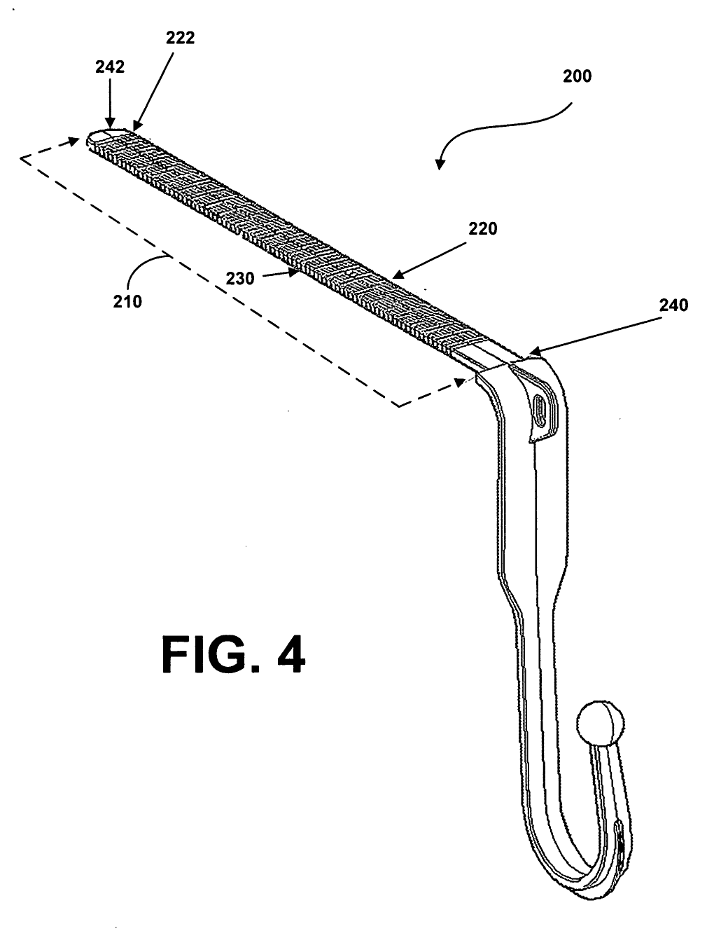

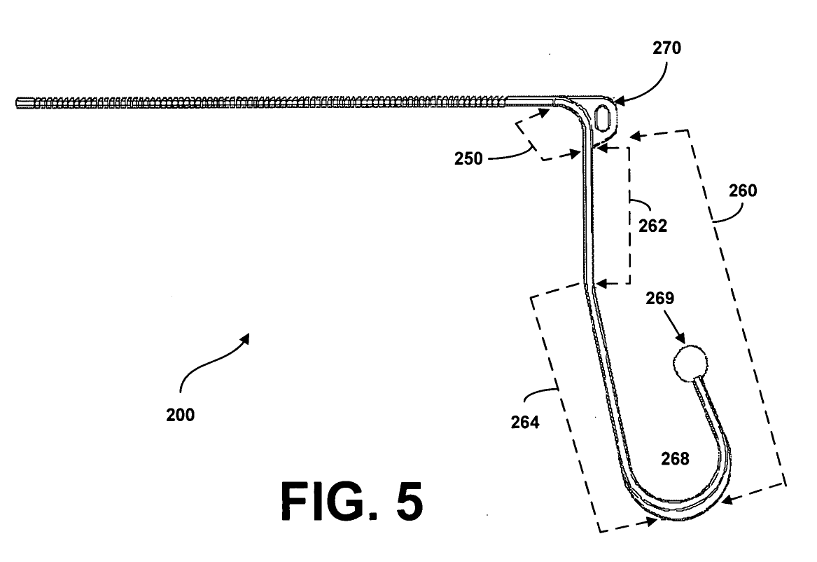

FIG. 4 is a perspective view of the main body 200 of the clip 100, while FIG. 5 is a side view of the main body 200 of FIG. 4. Referring to FIG. 4 and FIG. 5, the main body 200 contains an elongated portion 210 having a top surface 220 and a bottom surface 230. In accordance with a first exemplary embodiment of the invention, the elongated potion 210 is substantially flat. The elongated portion 210 also contains a proximate end 240 and a distal end 242.

It should be noted that length of the elongated portion 210 may vary depending on a width of the deck railing. Specifically, if the deck railing from which the clip 100 is to be attached, is very wide, the length of the elongated portion 210 would be larger. Fortunately, due to the end support 300 being adjustably connected to the elongated portion 210, as is described in additional detail hereinafter, the same clip 100 having a large elongated portion 210 may be used for deck railings that are large or small in width.

The top surface 220 of the elongated portion 210 contains a series of teeth 222 or grooves thereon. The series of teeth 222 located on the top surface 220 of the elongated portion 210 enable stopping of the end support 300, as is described in detail hereafter. The bottom surface 230 of the elongated portion 210 may either be flat or have a second series of teeth thereon. Specifically, during fabrication of the main body 200, the elongated portion 210 may be molded to have a series of teeth 222 on the top surface 220 alone, or on both the top surface 220 and the bottom surface 230. Of course, the series of teeth 222 may also be provided on the top surface 220 and/or the bottom surface 230 of the elongated portion 210 after fabrication, by using techniques known to those having ordinary skill in the art.

In accordance with an alternative embodiment of the invention, a different mechanism may be used for allowing the end support 300 to be adjustably connected to the elongated portion 210. As an example, the elongated portion 210 may have a series of holes therein, similar to a belt, where the end support 300 may be adjustably connected to the elongated portion 210 via use of a male portion that may be inserted into one of the holes when the end support 300 is in the correct position. Specifically, the manner of allowing the end support 300 to be adjustably connected to the elongated portion may differ as long as it provides for adjustable connectivity.

The main body 200 of the clip 100 contains a central loop portion 250, which is an extension of the proximate end 240 of the elongated portion 210. As is shown by FIGS. 1-5, the central loop portion 250 curves downward from the elongated portion 210 so as to form an extension that is almost perpendicular with the elongated portion 210.

A hook portion 260 extends from an end of the central loop portion 250 that is opposite the portion of the central loop portion 250 that is connected to the elongated portion 210. As a result of the curve of the central loop portion 250, a plane of the elongated portion 210 is substantially perpendicular to a plane of the hook portion 260. Specifically, the amount of downward curve of the central loop portion 250 dictates angle size between the elongated portion 210 and the hook portion 260.

The elongated portion 210, the central loop portion 250, and the hook portion 260 of the clip 100 may be connected together in many different ways. As an example, the clip 100 may be fabricated in a mold, thereby having the elongated portion 210, the central loop portion 250, and the hook portion 260 fabricated as one continuous piece. Alternatively, the elongated portion 210, the central loop portion 250, and the hook portion 260 may be connected by using glue or any other adhesive, or by use of a mechanical connector, such as screws and bolts.

The central loop portion 250 contains an eyelet 270. The eyelet 270 is located on a front portion of the central loop portion 250. It should be noted that the eyelet 270 may instead be located on the front of the hook portion 260, below the central loop portion 260.

The eyelet 270 extends outward from the central loop portion 250, in a plane that is substantially perpendicular to the plane of the hook portion 260. In addition, a length of the eyelet 270 extends downward from the end of the central loop portion 250 that is an extension of the elongated portion 210, to the end of the central loop portion 250 that is an extension of the hook portion 260.

The eyelet 270 is sized to allow larger or smaller objects to fit therein, or to run therethrough. As an example, a bow may be connected to the clip 100 through the eyelet 270. If the bow is very large, a portion of the bow used for connecting to the clip 100 may be very large as well, thereby requiring a larger eyelet 270.

It should be noted that a string of lights may also be run through the eyelet 270. The eyelet 270 is enclosed by a top, bottom, front, and back portion of the eyelet 270, with access to the eyelet 270 being provided from a left and right open portion of the eyelet 270.

The eyelet 270 permits substantial flexibility in that an additional article may be supported, compared to having just the hook portion 260 for support. The eyelet 270 may be attached to the central loop portion 250 in many ways. As an example, the eyelet 270 may be molded as a portion of the clip 100 or the eyelet 270 may be an attachment capable of being connected to the central loop portion 250.

The hook portion 260 of the clip 100 is an extension of the central loop portion 250, where a first portion 262 of the hook portion 260 extends from the central loop portion 250, and where a second portion 264 of the hook portion 260 is located at an end opposite the first portion 262 of the hook portion 260. Length of the hook portion 260 is determined by the use of the clip 100 and desired spacing between a first object situated within the eyelet 270 and a second object situated on the hook portion 260. In addition, thickness of the hook portion 260 may be determined by the weight of the second object situated on the hook portion 260. As an example, if the second object situated on the hook portion 260 is heavy, it may be desirable to make the hook portion 260 thicker so as to be capable of supporting the second object without stretching or breaking the clip 100. Of course, thickness of the hook portion 260 may also depend on the type of material from which the hook portion 260 is fabricated, since a stronger material would not necessitate larger thickness for the same strength.

In accordance with the first exemplary embodiment of the invention, the hook portion 260, while straight, is also slightly angled inward toward the eyelet 270. As is shown by FIG. 2 and FIG. 5, a plane of the first portion 262 of the hook portion 260 meets a plane of the second portion 264 of the hook portion 260 at less than 180 degrees. This shape of the hook portion 260 provides for better holding of the second object within the hook portion 260. It should be noted, however, that in accordance with a second exemplary embodiment of the invention, the plane of the first portion 262 of the hook portion 260 may meet the plane of the second portion 264 of the hook portion 260 at 180 degrees. The second portion 264 of the hook portion 260 is curved in shape defining a support zone 268 where the second object may be supported or hung.

Shape of the second portion 264 of the hook portion 260 may also differ in accordance with the second object. As an example, if the second object is small, the second portion 264, which is in the shape of a hook, may be small in size (i.e., a loop of the second portion 264 being small so as to define a “J” shape). Alternatively, if the second object is large, it may be necessary for the second portion 264 of the hook portion 260 to be large (i.e., the loop of the hook portion being large so as to define a “U” shape). Specifically, large objects residing on the support zone 268 of the hook portion 260 may require an end of the second portion 264 to extend further toward the eyelet 270 than would smaller objects. It should also be noted that the hook portion 260 may be fabricated from the same material as the rest of the clip 100 or from a different material. Such material may include, but is not limited to, wood, plastic, composite materials, metals, and alloys.

The second portion 264 of the hook portion 260 may end in a mechanical structure 269 that is capable of hindering the second object from coming off the second portion 264 of the hook portion 260. It should be noted, however, that the mechanical structure 269 is not a necessary component of the clip 100. An example of use of the mechanical structure 269 may be when garland or a string is brought past the mechanical structure 269 and placed in the support zone 268 to hang. The mechanical structure 269 would offer resistance to removal of the garland if the garland is capable of sliding out of the support zone 268, thereby keeping the garland in contact with the second portion 264 of the hook portion 260. The mechanical structure 269 may be a sphere, a cone, an ellipsoid, or the like, where the dimensions of the mechanical structure 269 are a little wider than the dimensions of the second portion 264 of the hook portion 260. It should be noted that, in accordance with an alternative embodiment of the invention, the hook portion 260 may instead be shaped as an L.

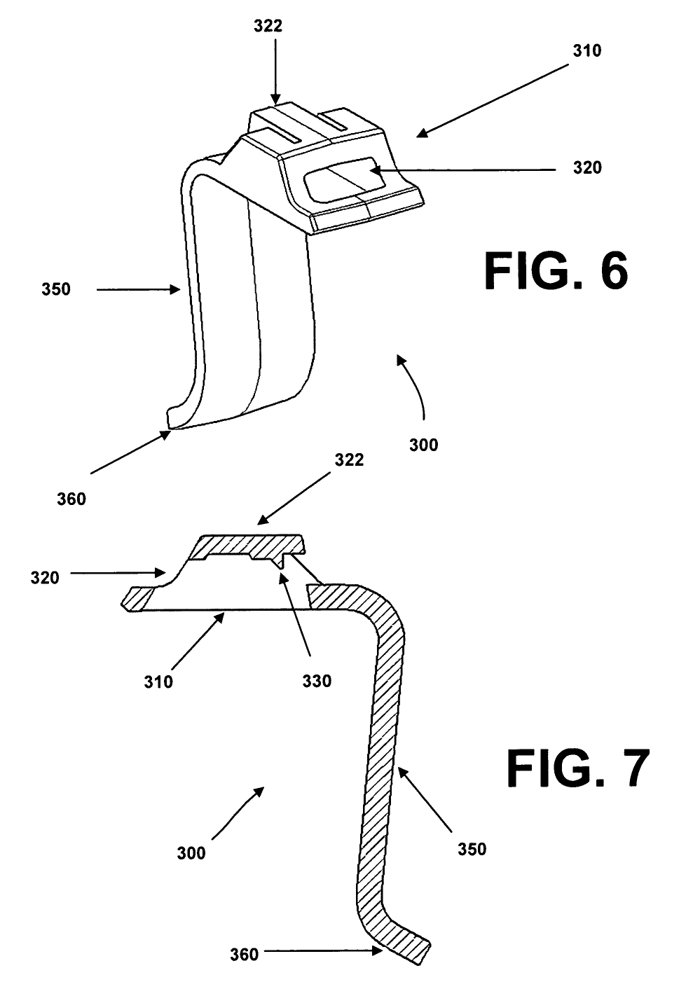

FIG. 6 is a perspective view, and FIG. 7 is a cross-sectional view, of the end support 300, in accordance with the first exemplary embodiment of the invention. As is shown by FIG. 6 and FIG. 7, the end support 300 contains a top portion 310 and a side portion 350. The top portion 310 has an opening 320 therein that is sized to allow the elongated portion 210 to fit therein. Therefore, the opening 320 is slightly larger in height and width than the elongated portion 210.

The top portion 310 of the end support 300 also has a top resilient flap 322 thereon that is located directly above the opening 320. A ridge 330 is located on a bottom portion of the flap 322, facing toward the opening 320. Memory of the flap 322, causing the flap 322 to want to return to an original position, causes the flap 322 and ridge 330 to be forced up over the series of teeth 222 of the elongated portion 210 as the elongated portion 210 is inserted within the opening 320 of the top portion 310, while still applying pressure down on the elongated portion 210.

The end support 300 is capable of being adjusted along the length of the elongated portion 210 until an appropriate length of the elongated portion 210 is reached. Specifically, the end support 300 of the clip 100 is adjusted until a distance from the side portion 350 of the end support 300 to a back portion of the first portion 262 of the hook portion 260 is about the same distance as a width of the deck railing on which the clip 100 is being supported. When the end support 300 is at the correct location, based upon width of the deck railing, the ridge 330 of the top portion 310 fits between two teeth of the series of teeth 222 located on the top surface 220 of the elongated portion 210. Since the flap 322 has a memory, the ridge 330 is maintained between the two teeth.

As is shown by FIG. 6 and FIG. 7, the side portion 350 of the end support 300 is an extension of the top portion 310 of the end support 300, where the side portion 350 extends down from the top portion 310 so that a plane of the top portion 310 is almost perpendicular to a plane of the side portion 350. It should be noted that the plane of the top portion 310 need not be perpendicular to the plane of the side portion 350. Instead, as long as the deck railing may be maintained between the side portion 350 and the back of the first portion 262 of the hook portion 260, the plane of the top portion 310 may be at a different angle to the plane of the side portion 350.

FIG. 6 and FIG. 7 illustrate the presence of a lip 360 located at an end of the side portion 350 that is opposite an end of the side portion 350 that is a extension of the top portion 310. The lip 360 makes removal of the clip 100 from the deck railing easier. The lip 360 also prevents scratching of the deck railing when placing the clip 100 on the deck railing. It should be noted, however, that the clip 100 may be provided without the lip 360.

It should be emphasized that the above-described embodiments of the present invention are merely examples of implementation, merely set forth for a clear understanding of the principles of the invention. Many variations and modifications can be made to the above-described embodiments of the invention without departing substantially from the spirit and principles of the invention. All such modifications and variations are intended to be included herein within the scope of this disclosure and the present invention. The following claims protect all such modifications and variations.

What is claimed is:

1. An apparatus capable of displaying a first object and a second object on a structure, comprising:
an elongated portion having a top surface and a bottom surface, and having a proximate end and a distal end;
a central loop portion extending from the proximate end of the elongated portion, where the central loop portion contains an eyelet that is entirely enclosed on a top portion, a bottom portion, a front portion, and a back portion of the eyelet, and the eyelet being open on a left side portion and a right side portion of the eyelet, wherein the eyelet is capable of allowing the second object to be situated in the eyelet after being placed within the left side portion or the right side portion of the eyelet;
a hook portion extending from the central loop portion, where the hook portion is capable of allowing the first object to be set thereon; and
an end support capable of being adjustably connected to the elongated portion so as to allow the apparatus to hold to the structure, based upon size of the structure.

2. The apparatus of claim 1, wherein the end support further comprises a top portion having an opening therein capable of receiving the elongated portion, where the top portion contains a ridge on a portion of the top portion that faces the opening, and wherein the top surface of the elongated portion contains a series of teeth, where the end support is capable of being adjusted on the elongated portion through the ridge being maintained between two teeth of the series of teeth.

3. The apparatus of claim 1, where the hook portion further comprises:
a first portion that is an extension of the central loop portion; and
a second portion that is an extension of the first portion, where the second portion provides a support zone on which the first object rests.

4. The apparatus of claim 3, where the second portion is in the shape of a J.

5. The apparatus of claim 3, where the second portion is in the shape of a U.

6. The apparatus of claim 3, wherein a plane of the first portion meets a plane of the second portion at an angle of less than 180 degrees.

7. The apparatus of claim 3, wherein a plane of the first portion meets a plane of the second portion at an angle of 180 degrees.

8. The apparatus of claim 1 where the structure is a railing of a deck.

9. The apparatus of claim 3, where the second portion of the hook portion ends in a mechanical structure capable of assisting in preventing the first object from falling out of the hook portion.

10. The apparatus of claim 1, where the elongated portion, the central loop portion, and the hook portion, are fabricated as a single continuous piece.

11. The apparatus of claim 1, where the elongated portion, the central loop portion, and the hook portion, are fabricated as separate pieces that are connected.

12. The apparatus of claim 1, wherein the end support further comprises a top portion having an opening therein capable of receiving the elongated portion, where the top portion contains a first means for removably securing located on a portion of the top portion that faces the opening, and wherein the top surface of the elongated portion contains a second means for removably securing, where the end support is capable of being adjusted on the elongated portion through the first means for removably securing being temporarily maintained by the second means for removably securing.
